(19) United States
(12) Patent Application Publication
(10) Pub. No.: US 2025/0010361 A1
(43) Pub. Date: Jan. 9, 2025

(54) VALVE DEVICE OF A METERING DEVICE FOR METERING MOLTEN METAL

(71) Applicant: Volkswagen Aktiengesellschaft, Wolfsburg (DE)

(72) Inventors: Erol EREN, Felsberg (DE); Michael KLEE, Gudensberg (DE); Klaus REINDEL, Erlangen (DE); Siegfried Heinrich WUEST, Baunatal (DE); Mirco WOELLENSTEIN, Kassel (DE); Matthias HOERDLER, Kassel (DE)

(73) Assignee: Volkswagen Aktiengesellschaft, Wolfsburg (DE)

(21) Appl. No.: 18/892,534

(22) Filed: Sep. 22, 2024

Related U.S. Application Data
(63) Continuation of application No. PCT/EP2023/056919, filed on Mar. 17, 2023.

(30) Foreign Application Priority Data
Mar. 22, 2022 (DE) 10 2022 202 774.4

(51) Int. Cl. B22D 17/30; B22D 17/32; G01F 11/16

(52) U.S. Cl. CPC B22D 17/30; B22D 17/32; G01F 11/16

(57) ABSTRACT

A valve device of a metering device for metering molten metal, in particular for a pressure casting installation, comprising a cylinder, which has an inlet opening, an outlet opening, and a metering opening, and a piston, which is movably arranged in the cylinder in the longitudinal direction of the cylinder such that the piston can be brought into a first position and a second position. The piston is designed to block a fluidic connection between the inlet opening and the outlet opening and release a fluidic connection between the inlet opening and the metering opening in the first position. The piston is designed to block a fluidic connection between the inlet opening and the metering opening and release a fluidic connection between the metering opening and the outlet opening in the second position.

This nonprovisional application is a continuation of International Application No. PCT/EP2023/056919, which was filed on Mar. 17, 2023, and which claims priority to German Patent Application No. 10 2022 202 774.4, which was filed in Germany on Mar. 22, 2022, and which are both herein incorporated by reference.

### BACKGROUND OF THE INVENTION

### Field of the Invention

The present invention relates to a valve device of a metering device for metering molten metals, in particular for a die casting installation. The invention furthermore relates to a metering device for metering molten metals, as well as a die casting installation.

### Description of the Background Art

Die casting installations are known, with the aid of which metal components made from molten metal, for example aluminum, may be manufactured. Molten metal which is situated in a casting chamber is usually pressed into a casting mold under high pressure to manufacture the metal component. Before the molten metal is supplied to the casting chamber, it is usually stored in a holding furnace, in which a large quantity of molten metal may be received and kept liquid, for example by heating. The molten metal is removed from the holding furnace with the aid of a metering device and frequently supplied to the casting chamber via a tubular metering chute. For the purpose of precisely metering the molten metal, the metering device usually includes a valve device to be able to release and stop the flow of the melt. Due to the aggressive environment to which a valve device of this type is exposed, a very robust and resistant construction of the valve device is usually needed. However, the metering precision is frequently limited thereby.

### SUMMARY OF THE INVENTION

It is therefore an object of the present invention to provide a valve device for a metering device for metering molten metals, which, with a simple construction, facilitates a high metering precision when used for metering molten metals. Another object of the invention is to provide a metering device, which facilitates a metering of molten metals with high precision. An object of the present invention is furthermore to provide a die casting installation, which is suitable for being able to manufacture metal components efficiently and with high precision.

The valve device according to an example of the invention comprises a cylinder, which has an inlet opening and an output opening and a metering opening. The cylinder is preferably designed as a straight tube. The valve device also comprises a piston, which is displaceably arranged within the cylinder in the longitudinal direction of the cylinder in such a way that the piston may be brought into a first position and into a second position. The piston is designed to block a fluidic connection between the inlet opening and the outlet opening of the cylinder and to release, in particular simultaneously, a fluidic connection between the inlet opening and the metering opening in the first position. The piston is furthermore designed to block a fluidic connection between the inlet opening and the metering opening of the cylinder and to release, in particular simultaneously, a fluidic connection between the metering opening and the outlet opening in the second position.

In other words, a valve device is provided, which has three openings arranged in one cylinder. Two of these three openings may in each case be fluidically connected to each other by the piston, which is displaceable within the cylinder. Moving the piston into one of the two positions therefore makes it possible to easily switch between different fluid paths.

The valve device is characterized by a construction which is particularly easy and economical to manufacture and which, on the one hand, is suitable for the use of particularly resistant materials for pistons and/or cylinders, and, on the other hand, facilitated reliable and precise switching operations for releasing and blocking fluid paths. In particular, due to the design with the displaceable piston, which releases and blocks different fluid connections in each case in the two positions, a possibility is provided for the particularly reliably controllable actuation of all valve positions. In other words, each of the two positions may be easily set by actively displacing the piston, which is characterized in that the molten metal may be metered with particularly high precision.

All openings of the cylinder, i.e., the inlet opening, the outlet opening, and the metering opening, each advantageously can have an identical opening cross-section.

The cylinder can be made up of a straight hollow tube. In other words, the cylinder is designed exclusively as a straight tube with a single straight, cylindrical hollow space inside. In particular, the cylinder is designed as a single-walled hollow tube.

The hollow tube can have a constant wall thickness over its entire length. A particularly easy and economical construction and manufacturing of the cylinder may be made possible thereby. It is also advantageous that a constant heat distribution within the cylinder as well as in the melt situated therein may also be reliably provided, which has an advantageous effect on a uniform casting quality. For example, a fast heating which is uniform in all areas of the cylinder is possible when the cylinder is, for example, surrounded by melt, and/or melt is situated within the cylinder.

The cylinder can be designed with multiple parts, preferably made up of multiple tube segments joined together. For example, the tube segments may be partially inserted into each other, whereby a simple and flexible assembly of the cylinder is possible. The tube segments may advantageously be provided with an at least partially identical design, whereby a particularly easy and economical manufacturing of the cylinder is made possible. For example, the inlet opening and/or the outlet opening and/or the metering opening may be easily produced as bores in a wall of the tube segment.

The piston can be designed as a single one-piece component. In other words, a single one-piece piston is provided, which is arranged in the interior of the single straight, cylindrical hollow space in the cylinder. A particularly easy and economical construction and manufacturing of the valve device may thus be made possible thereby.

The inlet opening can be arranged in an end face of the cylinder in the longitudinal direction. In other words, the inlet opening is formed by an end face, in particular, an end-face opening, of the cylinder. A particularly easy and economical construction of the cylinder may be provided thereby, which permits, for example, a short axial length of the cylinder.

The inlet opening can be designed as a through-opening, which penetrates a wall of the cylinder in the radial direction of the cylinder. An alternative construction of the cylinder may be provided thereby, which permits, for example, an easy manufacturing of the cylinder.

The outlet opening and the through-opening can be designed as through-openings which penetrate the wall of the cylinder in the radial direction. A particularly easy and economical ability to manufacture the cylinder may be ensured thereby. In addition, the release and blocking of the different fluidic connections at the two positions of the piston may be easily and reliably made possible.

The inlet opening and the outlet opening and the metering opening can also be arranged in different positions along the longitudinal direction of the cylinder. The metering opening is arranged along the longitudinal direction of the cylinder, between the inlet opening and the outlet opening. As a result, the release and blocking of the particular fluidic connections may be particularly easily made possible by displacing the piston, while having a simple and material-saving construction of the valve device.

The outlet opening and the metering opening can be arranged at the same position with respect to the circumferential direction of the cylinder; i.e., particular opening axes of the outlet opening and the metering opening are, in particular, in parallel to each other. In the case that the inlet opening can be designed as a through-opening through the wall of the cylinder in the radial direction, the inlet opening is preferably additionally arranged at the same circumferential position of the cylinder as the outlet opening and the metering opening. In other words, all openings are oriented in the same way on the cylinder. An easy manufacturing of the cylinder may be made possible thereby, and an advantageous, space-saving arrangement of the cylinder may also be made possible when used within a metering device, since, for example, an inflow and outflow of melt always takes place on the same side of the cylinder.

The piston can include a first blocking section and a second blocking section and a connecting section. The first blocking section and the second blocking section are each designed to completely block a cylinder cross-section of the cylinder. In other words, each blocking section fills the cylinder cross-section entirely in the interior of the cylinder in a plane of intersection perpendicular to the longitudinal direction. The connecting section connects the first blocking section and the second blocking section to each other in the longitudinal direction. In particular, the connecting section is thus arranged along the longitudinal direction between the first blocking section and the second blocking section. The first blocking section and the second blocking section and the connecting section are preferably designed together as a one-piece component. The connecting section has a connecting cross-section, which is smaller than the cylinder cross section, in particular in the plane of intersection perpendicular to the longitudinal direction of the cylinder. A simple construction of the piston may be provided thereby, which makes the metering of the molten metal via the openings of the cylinder particularly easy and precise. For example, the piston may be designed in such a way that, in the first position, the inlet opening and the metering opening are arranged in the longitudinal direction between the first blocking section and the second blocking section, the outlet opening or the fluidic connection to the outlet opening being blocked by the second blocking section. The fluidic connection between the inlet opening and the metering opening may take place via the interior of the cylinder, due to the reduced connection cross-section of the connecting section. Similarly, the piston may be designed, for example, in such a way that, in the second position, the metering opening and the outlet opening are arranged in the longitudinal direction between the first blocking section and the second blocking section, the inlet opening or the fluidic connection to the inlet opening being blocked by the first blocking section. The fluidic connection between the metering opening and the outlet opening may take place, similarly to the first position, via the interior of the cylinder, due to the reduced connection cross-section.

A free metering cross-section between the connecting section and a wall of the cylinder can correspond essentially to an opening cross-section of the inlet opening or the metering opening or the outlet opening. The inlet opening, outlet opening, and metering opening preferably each have an identical opening cross-section. The metering cross-section particularly preferably corresponds to at least 80%, preferably no more than 130%, of the opening cross-section. This makes it possible to advantageously ensure that uniform free flow cross-sections are present in the valve device, whereby an unhindered flow of the melt is made possible.

The connecting cross-section preferably corresponds to no more than 70%, preferably no more than 50%, of the cross-sectional area of the cylinder cross-section.

The valve device preferably further comprises a metering tube, which opens into the outlet opening in the cylinder. The metering tube can be fixedly connected to the cylinder. For example, the molten metal which may be metered by the displacement of the piston may be passed on via the metering tube.

The metering tube can include a first metering tube section, which extends away from the outlet opening of the cylinder in the radial direction of the cylinder. The metering tube preferably also includes a second metering tube section, which is arranged in parallel to the cylinder and is connected, in particular, to the first metering tube section. A particularly simple construction of the valve device may be provided thereby, the cylinder and metering tube being able to be provided, for example, completely from straight tubes or tube sections. Both the metering tube and the cylinder can be each formed from multiple tube sections connected to each other, all tube sections preferably having an identical geometry. A particularly easy and economical construction and manufacturing of the valve device may be made possible thereby.

The valve device is can be at least partially formed from ceramic, preferably silicon carbide. A particularly high durability of the valve device may be made possible thereby, which is suitable, for example, for use in molten aluminum. Alternatively, the valve device is preferably suitable thereby for use in molten magnesium.

The entire valve device can be formed exclusively from ceramic, in particular silicon carbide.

The valve device preferably can further comprise an actuating device, which is designed to controllably displace the piston along the longitudinal direction of the cylinder. The actuating device preferably includes a connecting rod, which is connected to the piston and extends within the cylinder along the longitudinal direction of the cylinder, and also a motor, which is designed to displace the connecting rod along the longitudinal direction. For example, the actuating device may comprise a linear motor as the motor.

The invention furthermore leads to a metering device for metering molten metals, in particular for a die casting installation. The metering device can comprise a metering container, which has a metering chamber for receiving molten metal. The metering device also comprises the valve device described above. The metering opening of the valve device is fluidically connected to the metering chamber of the metering container. The molten metal situated in the metering container may thus be easily and efficiently metered with high precision with the aid of the valve device.

The valve device can be arranged within the metering container. The metering container can have a container opening, the inlet opening of the cylinder of the valve device being fluidically connected to the container opening of the metering container. For example, the inlet opening and the container opening may be designed together as a single opening. Alternatively, the cylinder can protrude through the container opening of the metering container. In this case, the inlet opening is preferably situated outside the metering container, in particular the metering opening and the outlet opening of the cylinder being situated within the metering container.

The metering chamber and the container opening can be fluidically connected to each other exclusively via the cylinder. In other words, a filling of the metering chamber with melt may take place exclusively via the valve device, specifically via the inlet opening and metering opening of the cylinder.

The container opening can be arranged in a base of the metering container, preferably designed as a through-opening which penetrates the base. The cylinder can be arranged vertically, in particular above the container opening or at least partially protruding through the container opening. The cylinder is preferably arranged partially within the container opening, in particular inserted therein. This makes it possible to particularly advantageously use the entire volume of the metering container, or the largest possible portion thereof, for the purpose of metering.

The metering device can also comprise a pressure device, which is designed to generate an underpressure and/or an overpressure within the metering chamber. For example, the pressure device may be arranged on a cover of the metering container, which is preferably completely closed. By generating an underpressure, the metering container may be filled with molten metal via the valve device, for example from a holding furnace surrounding the metering container. By generating an overpressure, the molten metal may be discharged from the metering container, i.e., metered, via the valve device. The pressure device is preferably arranged outside the metering container, making it possible to use many different kinds of pressure devices.

The metering device can further comprise a fill level sensor, which is arranged, in particular, on a cover of the metering container. In particular, the fill level sensor is designed to detect a completely filled metering container. For example, the fill level sensor may comprise two electrodes, which protrude into the metering chamber from the cover, whereby a particularly simple and economical fill level sensor may be provided. The fill level sensor is preferably designed to actuate the pressure device depending on the fill level of the metering container, preferably to deactivate the pressure device when a completed filled metering container has been detected.

The fill level sensor can be designed to generate a signal depending on a fill level of the metering chamber. The metering device can also include a control unit, which is designed to actuate the pressure device and/or the actuating device, controlled at least partially depending on the signal of the fill level sensor. A controlled or, for example also regulated, metering of the melt may thus take place with the aid of the metering device.

The invention also leads to a die casting installation, in particular for die-casting molten metals, preferably aluminum or magnesium. The die casting installation comprises a holding furnace, which has a receiving chamber for receiving molten metal. The holding furnace is preferably designed to heat the receiving chamber. The die casting installation further comprises the described metering device. The metering device is arranged at least partially within the receiving chamber of the holding furnace. In particular, the metering device is arranged at least partially within the molten metal when the receiving chamber is filled with molten metal.

The container opening of the metering container can be arranged completely within the receiving chamber. In other words, melt situated in the receiving chamber may be removed from the receiving chamber, i.e., metered, directly via the container opening of the metering container. The valve device of the metering device permits a precise control of the quantity or the volume flow of metered melt.

The die casting installation can also comprise a casting chamber and a metering chute. The metering chute is designed to fluidically connect the metering device to the casting chamber. The metering chute is preferably fluidically connected to the outlet opening of the cylinder of the valve device via a metering tube of the valve device. The metering chute is arranged in an ascending manner in the vertical direction from the metering device in the direction of the casting chamber. In other words, the casting chamber may be arranged higher with respect to the vertical direction than the metering device, the metering chute being arranged in an ascending manner toward the casting chamber with respect to the vertical direction. Due to the valve device, which permits a precise and reliable blocking and release of the fluid flows, a backflow of molten metal back into the metering chamber may be particularly reliably prevented.

The die casting installation further can comprise an injection device, which is designed to transport the melt which was metered with the aid of the metering device, into a casting mold. The casting chamber is preferably part of the injection device in this case. In particular, the injection device includes a shot piston, which is designed to transport the metered melt into the casting mold under high pressure. For example, the shot piston may be arranged horizontally. In particular, the injection device is designed as a separate device from the valve device. The shot piston and the piston of the valve device are preferably designed to be movable and/or actuatable separately from each other. In other words, the shot piston and the piston of the valve device may be moved and actuated entirely independently of each other. In particular, a time-shifted movement of the shot piston and the piston of the valve device is possible. As a result, a particularly flexible design and operation of the die casting installation is possible.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a sectional view of a valve device according to an example of the invention;

FIG. 2 shows a simplified schematic view of a die casting installation, including the valve device from FIG. 1, in a first position;

FIG. 3 shows a simplified schematic view of the die casting installation from FIG. 2, including the valve device from FIG. 1, in a second position; and

FIG. 4 shows a sectional view of a metering device, including a valve device according to an example of the invention.

### DETAILED DESCRIPTION

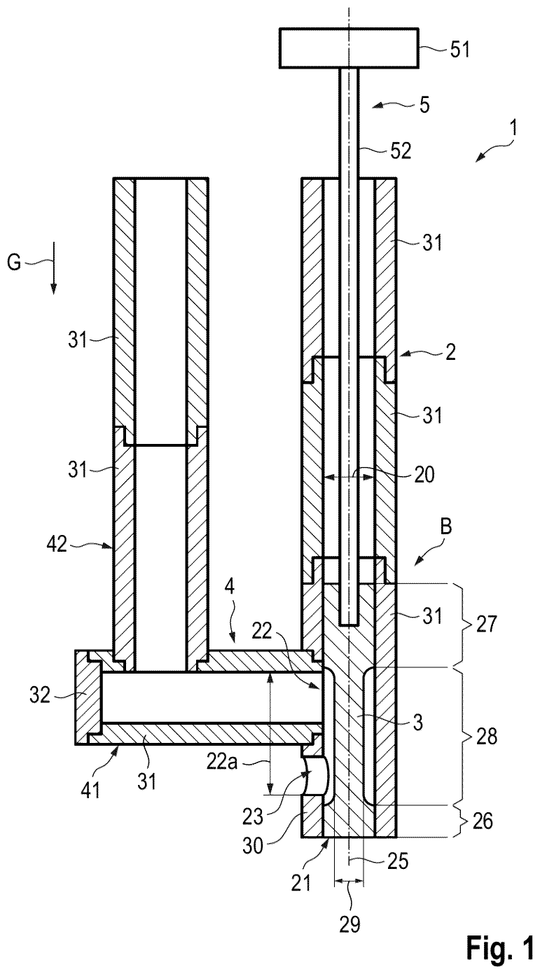

Examples of a valve device 1 according to the invention are described in greater detail below. Reference is made to FIGS. 1 through 4.

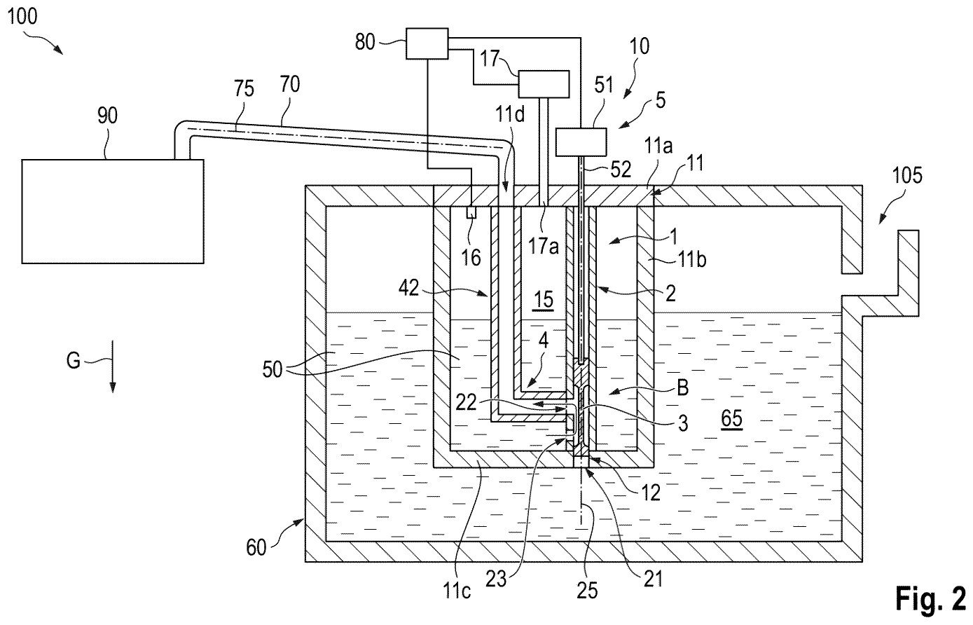

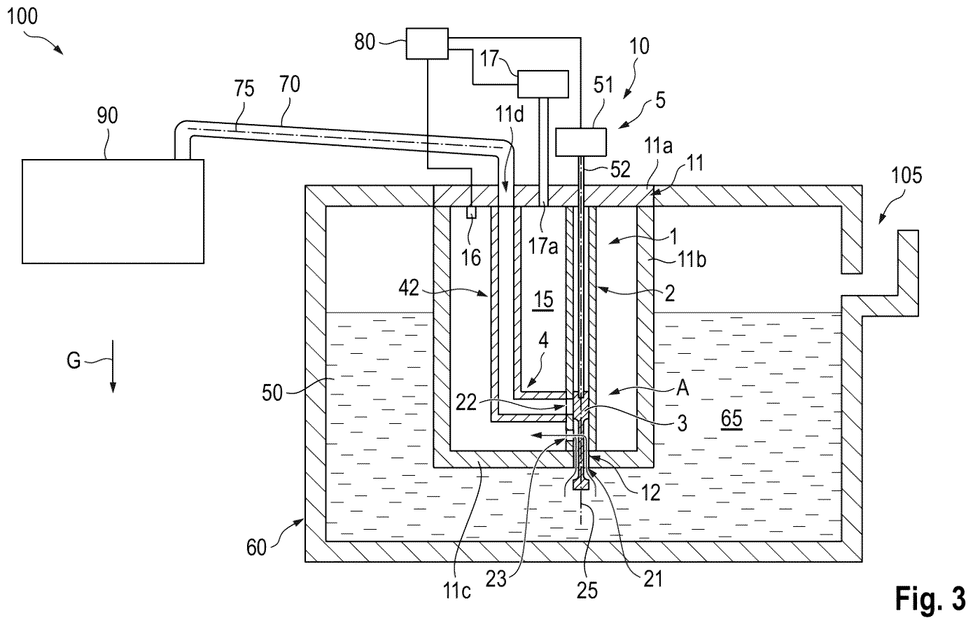

FIG. 1 shows a sectional view of a valve device 1 according to an example of the invention. Valve device 1 is designed for use in a metering device 10 for metering molten metals 50 in a die casting installation 100, which is described in detail later on with reference to FIGS. 2 and 3.

Valve device 1 comprises a cylinder 2, which is designed, in particular, as a straight tube and which extends along a longitudinal direction 25. Cylinder 2 is preferably made up of multiple tube segments 31 directly adjacent to each other along longitudinal direction 25, which are, in particular, partially inserted into each other to facilitate an easy and flexible assembly of cylinder 2.

Cylinder 2 has an inlet opening 21, an outlet opening 22, and a metering opening 23. Inlet opening 21, outlet opening 22, and metering opening 23 preferably have the same cross-sectional areas.

Inlet opening 21 is formed by an end face of cylinder 2 in longitudinal direction 25.

Outlet opening 22 and metering opening 23 are designed as through-openings, which penetrate a wall 30 of cylinder 2 in the radial direction. Outlet opening 22 and metering opening 23 are arranged at different positions along longitudinal direction 25 of the cylinder. Metering opening 23 is arranged along longitudinal direction 25 between inlet opening 21 and outlet opening 22.

Valve device 1 further comprises a metering tube 4, which opens into outlet opening 22 in the interior of cylinder 2. Metering tube 4 comprises a first metering tube section 41, which extends from outlet opening 22 in the radial direction of cylinder 2 and is inserted, in particular, partially into wall 30 of cylinder 2. Metering tube 4 also comprises a second metering tube section 42, which is arranged in parallel to cylinder 2. First metering tube section 41 and/or second metering tube section 42 is/are also preferably designed as straight tube segments 31, which are, in particular, partially inserted into each other. In particular, metering tube section 41 is closed on an end face facing away from cylinder 2 with the aid of a cover 32.

Valve device 1 also comprises a piston 3, which is displaceably arranged within cylinder 2 and along longitudinal direction 25 of cylinder 2.

To displace piston 3, valve device 1 comprises an actuating device 5, with the aid of which piston 3 may be controllably displaced. Actuating device 5 comprises a connecting rod 52, which is connected to piston 3 and which protrudes into cylinder 2. A motor 51 of actuating device 5 is also arranged outside cylinder 2, which is designed to controllably displace connecting rod 52 along longitudinal direction 25.

Piston 3 of valve device 1 comprises a first blocking section 26 and a second blocking section 27. The two blocking sections 26, 27 are each designed to completely block a cylinder cross-section 20 in the interior of cylinder 2. In particular, each of the two blocking sections 26, 27 is at;east partially designed as a solid cylinder having an outer diameter which corresponds to the inner diameter of cylinder 2.

Piston 3 also comprises a connecting section 28, which connects first blocking section 26 and second blocking section 27 to each other along longitudinal direction 25. Connecting section 28 is preferably designed at least partially as a straight cylinder, which extends along longitudinal direction 25. First blocking section 26, second blocking section 27, and connecting section 28 are designed together as a one-piece component. Connecting section 28 has a connecting cross-section 29, which is smaller than cylinder cross-section 20. A ratio of connecting cross-section 29 and cylinder cross-section 20 to each other is preferably designed in such a way that a cross-sectional area of free annular hollow space 35 between connecting section 28 and wall 30 of cylinder 2 is at least 50% of the cross-sectional area of inlet opening 21 or outlet opening 22 or metering opening 23.

An axial length of connecting section 28 is preferably greater than or equal to a maximum outer spacing apart 22a of outlet opening 22 and metering opening 23 along longitudinal direction 25.

Valve device 1 can be made entirely from ceramic, preferably silicon carbide, to be able to offer a resistance to molten metal, for example aluminum.

Piston 3 may be brought into a first position A and into a second position B by the displacement with the aid of actuating device 5. A fluidic connection may be provided between metering opening 23 and either outlet opening 22 or inlet opening 21, a fluidic connection between the other openings in each case being blocked. The precise functioning of valve device 1 in the two positions A, B as well as the use of valve device 1 is described in detail below with reference to FIGS. 2 and 3.

FIG. 2 shows a simplified schematic sectional view of a die casting installation 100, including valve device 1 from FIG. 1. Die casting installation 100 comprises a holding furnace 60, including a receiving chamber 65, in which molten metal 50 is received and may be stored, for example, for later use during die casting. For example, molten metal 50 may be filled into receiving chamber 65 of holding furnace 60 via a filling opening 105.

Die casting installation 100 also comprises a metering device 10, with the aid of which molten metal 50 may be removed and metered from receiving chamber 65. Molten metal 50 may be supplied to a casting chamber 90 by metering device 10 via a metering chute 70, which may be provided, for example, with an essentially tubular design. The correspondingly metered quantity of molten metal from casting chamber 90 may be used for the die casting process.

In particular, die casting installation 100 also includes an injection device, which is designed to transport the metered melt into a casting mold under high pressure. Casting chamber 90 is part of the injection device in this case. The injection device furthermore includes a shot piston, which may transport the melt into the casting mold. The shot piston may preferably be arranged horizontally. The shot piston and piston 3 are designed to be actuatable independently of each other and may therefore be operated in a time-shifted manner.

Metering device 10 comprises a metering container 11, which has a metering chamber 15, in which molten metal may be received. For example, a corresponding quantity of molten metal for the particular die-casting process may be received in metering chamber 15. A container 11b of metering container 11 is arranged within receiving chamber 65 and dips partially into molten metal 50.

Valve device 1 is arranged within metering container 11, i.e., in metering chamber 15. Inlet opening 21 of cylinder 2 is fluidically connected to a container opening 12 in a base 11c of metering container 11. In particular, container opening 12 and cylinder 2 are arranged in alignment.

Valve device 1 is arranged in such a way that longitudinal direction 25 of cylinder 2 is arranged vertically, i.e., in parallel to a gravitational direction G.

An upper end of cylinder 2 is preferably fastened to a cover 11a of metering container 11. Connecting rod 52 of actuating device 5 preferably protrudes through cover 11a of metering container 11, motor 51 being arranged outside metering container 11.

Metering opening 23 of cylinder 2 opens into the interior of metering container 11.

Metering tube 4 is fluidically connected to metering chute 70 via a discharge opening 11d in cover 11a of metering container 11.

Metering device 10 furthermore comprises a pressure device 17, which is designed to generate an underpressure and/or an overpressure within metering chamber 15. Pressure device 17 is arranged, in particular, outside metering container 11 and is fluidically connected to metering chamber 15 via a pressure opening 17a in cover 11a.

FIG. 2 shows a state during the metering of molten metal 50, i.e., while the molten metal situated in metering chamber 15 is being supplied to casting chamber 90 via metering chute 70. Piston 3 of valve device 1 is in second position B (cf. also FIG. 1).

In second position B, first blocking section 26 (cf. FIG. 1) of piston 3 is situated between inlet opening 21 and metering opening 23, so that a fluidic connection between inlet opening 21 and metering opening 23 is blocked. In this second position B, a fluidic connection between metering opening 23 and outlet opening 22 is simultaneously released, due to reduced connecting cross-section 29 of connecting section 28. As a result, molten metal 50 may flow out of metering chamber 15 into metering tube 4 via the interior of cylinder 2 and flow from there into metering chute 70 and into casting chamber 90 via discharge opening 11d. At the same time, second blocking section 27 (cf. FIG. 1) prevents molten metal 50 from being able to rise upward into the interior of cylinder 2.

To promote the metering of metal 50 in a targeted manner, an overpressure is generated within metering chamber 15 with the aid of pressure device 17 while piston 3 is in second position B.

FIG. 3 shows die casting installation 100 from FIG. 2 during the filling of metering container 11. During this process, piston 3 of valve device 1 is in first position A.

In first position A, first blocking section 26 of piston 3 is pushed downward out of inlet opening 21 as well as container opening 12 along longitudinal direction 25. In particular, piston 3 is pushed into such a position that metering opening 23 and inlet opening 21 are situated between first blocking section 26 and second blocking section 27 in longitudinal direction 25. In particular, an underside of second blocking section 27 is situated below outlet opening 22 with respect to vertical longitudinal direction 25. The fluidic connection to outlet opening 22 is completely blocked thereby, whereby a backflow of the melt out of metering tube 4 into metering chamber 15 is reliably prevented. At the same time, molten metal 50 may flow into metering chamber 15 from receiving chamber 65 via reduced connecting cross-section 29 of connecting section 28 for the purpose of filling metering container 11.

To promote the filling of metering container 11, an underpressure is generated within metering chamber 15 with the aid of pressure device 17 while piston 3 is in first position A.

The filling of metering chamber 11 may be stopped, based on a signal of a fill level sensor 16. Fill level sensor 16 is arranged in the interior of metering container 11, on cover 11a of metering container 11, and protrudes into metering chamber 15. During the filling of metering chamber 15, the melt rises in the direction of cover 11a until it touches fill level sensor 16. On this basis, it is possible to detect that metering chamber 15 is completely filled.

Metering device 10 further comprises a control unit 80, which actuates pressure device 17 and actuating device 5, controlled at least partially depending on the signal of fill level sensor 16.

Valve device 1 according to the invention offers the advantage that a very precise and reliable control of the fluid flow of molten metal 50 from holding furnace 60 to casting chamber 90 may be facilitated with a particularly simple and economical design. Not only may the start of the metering, i.e. the flow of the melt out of metering chamber 15 in the direction of casting chamber 90, be released in a particularly targeted and precise manner, but a backflow of the melt into metering chamber 15 may also be particularly reliably prevented. It is advantageously possible thereby to arrange metering chute 70 in an ascending manner from discharge opening 11d of metering container 11 in the direction of casting chamber 90 with respect to gravitational direction G. This makes it possible to lower the upper side of metering device 10 and holding furnace 60, i.e., to arranged it lower down, whereby a total height of die casting installation 100 may be reduced.

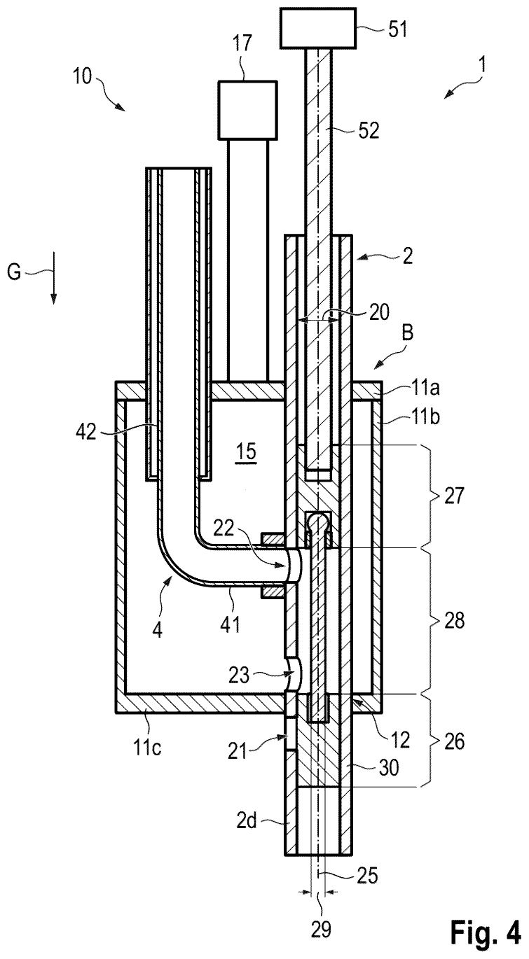

FIG. 4 shows a sectional view of a metering device 10, including a valve device 1 according to an example of the invention. This example essentially corresponds to the first example in FIGS. 1 through 3, with the difference of an alternative design of cylinder 2.

In the second example in FIG. 4, cylinder 2 is designed in such a way that it protrudes through container opening 12 in base 11c of metering container 11. Inlet opening 21 is designed as a through-opening, which penetrates wall 30 of cylinder 2 in the radial direction. Inlet opening 21 in this case is situated outside metering container 11. In other words, base 11c of metering container 11 is arranged between inlet opening 21 and metering opening 23. An alternative construction of valve device 1 may be provided thereby, which is, for example, easy to manufacture and is suitable for alternative space requirements in holding furnace 60.

In FIG. 4, similarly to FIG. 1, piston 3 is illustrated in second position B. Similarly to the first example, piston 3 in the second example in FIG. 4 is brought downward into first position A by displacing it along longitudinal direction 25, in particular, until inlet opening 21 and metering opening 23 are situated between first blocking section 26 and second blocking section 27.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A valve device of a metering device for metering molten metals for a die casting installation, the valve device comprising:
a cylinder that has an inlet opening, an outlet opening, and a metering opening; and
a piston displaceably arranged in the cylinder in a longitudinal direction of the cylinder so that the piston is adapted to be brought into a first position and into a second position, the piston being adapted to block a fluidic connection between the inlet opening and the outlet opening and to release a fluidic connection between the inlet opening and the metering opening in the first position, and the piston being adapted to block a fluidic connection between the inlet opening and the metering opening and release a fluidic connection between the metering opening and the outlet opening in the second position.

2. The valve device according to claim 1, wherein the cylinder formed of a straight hollow tube.

3. The valve device according to claim 1, wherein the piston is a single one-piece component.

4. The valve device according to claim 1, wherein the inlet opening is arranged on an end face of the cylinder in the longitudinal direction.

5. The valve device according to claim 1, wherein the Inlet opening is a through-opening, which penetrates a wall of the cylinder in a radial direction.

6. The valve device according to claim 1, wherein the outlet opening and the metering opening are designed as through-openings, which penetrate the wall of the cylinder in a radial direction.

7. The valve device according to claim 6, wherein the inlet opening and the outlet opening and the metering opening are arranged at different positions along the longitudinal direction of the cylinder, and wherein the metering opening is arranged between the inlet opening and the outlet opening in the longitudinal direction of the cylinder.

8. The valve device according to claim 1, wherein the metering opening and the outlet opening are arranged at a same circumferential position of the cylinder.

9. The valve device according to claim 1, wherein the piston has a first blocking section and a second blocking section and a connecting section, wherein the first blocking section and the second blocking section are each designed to completely block a cylinder cross-section of the cylinder, wherein the connecting section connects the first blocking section and the second blocking section to each other, and wherein the connecting section has a connecting cross-section, which is smaller than the cylinder cross-section.

10. The valve device according to claim 9, wherein a free metering cross-section between the connecting section and a wall of the cylinder essentially corresponds to an opening cross-section of the inlet opening or the outlet opening or the metering opening or at least 80% or no more than 130% of the opening cross-section.

11. The valve device according to claim 1, further comprising a metering tube, which opens into the outlet opening in the cylinder.

12. The valve device according to claim 11, wherein the metering tube has a first metering tube section, which extends from the outlet opening in the radial direction of the cylinder, and a second metering tube section is arranged in parallel to the cylinder.

13. The valve device according to claim 1, wherein the valve device is formed at least partially from ceramic or from silicon carbide.

14. The valve device according to claim 13, wherein the valve device is formed exclusively from ceramic or from silicon carbide.

15. The valve device according to claim 1, further comprising an actuating device, which is designed for the controllable displacement of the piston along the longitudinal direction of the cylinder.

16. A metering device for metering molten metals for a die casting installation, the metering device comprising:
a metering container that has a metering chamber for receiving molten metal; and
the valve device according to claim 1,
wherein the metering opening of the valve device is fluidically connected to the metering chamber of the metering container.

17. The metering device according to claim 16, wherein the valve device is arranged within the metering container, wherein the metering container has a container opening, and wherein the inlet opening of the cylinder is fluidically connected to the container opening of the metering container or the cylinder penetrating through the container opening of the metering container.

18. The metering device according to claim 17, wherein the metering chamber and the container opening are fluidically connected to each other exclusively via the cylinder.

19. The metering device according to claim 17, wherein the container opening is arranged in a base of the metering container, or wherein the cylinder is arranged vertically or partially within the container opening.

20. The metering device according to claim 16, further comprising a pressure device, which is designed to generate an underpressure and/or an overpressure within the metering chamber.

21. The metering device according to claim 16, further comprising:
a fill level sensor, which is designed to generate a signal depending on a fill level of the metering chamber; and
a control unit, which is designed to actuate the pressure device and/or the actuating device controlled at least partially depending on the signal of the fill level sensor.

22. A die casting installation comprising:
a holding furnace, which has a receiving chamber for receiving molten metal; and
a metering device according to claim 16, the metering device being arranged at least partially within the receiving chamber of the holding furnace.

23. The die casting installation according to claim 22, wherein the container opening of the metering container is arranged completely within the receiving chamber.

24. The die casting installation according to claim 22, further comprising:
a casting chamber; and
a metering chute, which is designed to fluidically connect the metering device to the casting chamber,
wherein the metering chute is fluidically connected to the outlet opening of the cylinder of the valve device via a metering tube of the valve device, and
wherein the metering chute is arranged in an ascending manner in a vertical direction from the metering device in a direction of the casting chamber.

25. The die casting installation according to claim 22, further comprising an injection device, which is designed to transport a melt metered with the aid of the metering device into a casting mold or via a shot piston.
